(19) United States
(12) Patent Application Publication
(10) Pub. No.: US 2009/0294262 A1
(43) Pub. Date: Dec. 3, 2009

(54) LOW PROFILE ROTARY SWITCH WITH AN ENCLOSED DETENT SUB-ASSEMBLY

(76) Inventors: Donald Horton, Canoga Park, CA (US); William J. Miller, Fullerton, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/472,031

(22) Filed: May 26, 2009

Related U.S. Application Data
(63) Continuation of application No. 10/523,342, filed on Jan. 27, 2005.
(60) Provisional application No. 60/407,159, filed on Aug. 29, 2002.

(51) Int. Cl. H01H 19/02

(52) U.S. Cl. 200/11 R

(57) ABSTRACT

The panel mounted low profile rotary switch includes a knob, a detent sub-assembly, a shaft, a bushing, and a panel. The knob is held to the shaft by one or more locking screws and the operation of the detent sub-assembly is enclosed and is not altered by removal of the knob. The entire detent sub-assembly is located on the knob side or user's side of the panel. Only the bushing and the shaft extend through the panel. The shaft is connected to a rotary component such as a rotary switch contact which engages circuitry on a printed circuit board. The switch or electrical connection is located on the undersurface of the panel.

### CROSS-REFERENCE TO RELATED APPLICATIONS

This application is a continuation of U.S. patent application Ser. No. 10/523,342 filed Jan. 27, 2005 which claims the benefit of PCT Application Number PCT/US02/35610 filed on Nov. 5, 2002 which claims the benefit of U.S. Provisional Application No. 60/407,159 filed on Aug. 29, 2002. All of the applications referenced in this paragraph are hereby incorporated by reference in their entirety.

### FIELD OF THE INVENTION

The field of the invention is electromechanical rotary switches.

### BACKGROUND OF THE INVENTION

A rotary electromechanical switch is generally defined as a device that has a rotating shaft connected to one terminal capable of making or breaking a connection to one or more other terminals. A rotary electromechanical encoder includes the overall characteristics of a rotary switch, but has additional mechanical movements. In any case, a user typically manipulates the switch to manually select a circuit.

Rotary switches and encoders are often mounted upon panels and other supporting structures in order that a user may control an electrical device. It is common for a portion of the switch to be on one side of the panel (the user side) and another portion of the switch to be on the other side of the panel (the inside). In many instances, the only portion of a switch that is on the user's side of the panel is a section of the shaft and a knob or other actuating means. Generally, the bulk of the switch is on the inside of the panel. For many years this type of configuration was sufficient, but over time the size of electrical devices has become increasingly smaller and there has become a need to reduce the size of the switch—especially that portion on the inside of the panel.

In order to meet the needs of smaller devices having less room under the panel, the size of the components of the switches have also become smaller. Yet, because these switches are comprised in part of mechanical components, there remained a practical limit as to how small they could become while still remaining useful. There became a need for different designs rather than just a reduction in the size of the components. One such design is taught in U.S. Pat. No. 4,454,391 to Olsson (June 1984). Olsson describes a low profile dip switch used on an integrated circuit board in which the actuating member of the dip switch is set within the-body of the switch. By reducing the vertical profile of the switch, a lower overall footprint may be achieved for a board. The switch design taught by Olsson, however; does not address design problems related to panel mounted switches. Another patent which addresses problems in the design of switches is described in U.S. Pat. No. 6,312,288 to Genz et al. (November 2001). Genz teaches a low profile combination switch and connector assembly. While the switch described by Genz may have resulted in a lower overall profile of the combined components, this switch still does not address problems of panel mounted switches, specifically those problems due to limited space under the panel.

U.S. Pat. No. 6,043,855 to Grave (March 2000) is directed toward switches that mount on a bezel surrounding an LCD which is located on an avionics panel in an aircraft. The '855 patent teaches a design in which the detent is at least partially positioned in the knob of the switch. Still, the design of the '855 patent has its shortcomings: the detent is housed by the knob such that if the knob were to be displaced, the switch would not function or would function improperly; the detent is not entirely within the knob; the design requires two springs; and the springs are mounted vertically adding to the overall vertical profile of the knob.

As electronic devices become even smaller, there is a need for more compact designs and designs which have less dependence on the knob.

### SUMMARY OF THE INVENTION

The inventive subject matter is a low profile switch having a detent mechanism on the outside of a panel on which the switch is mounted. The switch has a single substantially horizontal spring as part of the detent mechanism, and the detent sub-assembly is substantially covered by the knob. Another aspect includes devices and methods of use in which the switch operates independently of the knob.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1a is a prior art rotary switch.

FIG. 1b is a cross-sectional view of a rotary switch.

FIG. 2 is a perspective view of a partially exploded rotary switch.

FIG. 3 is a perspective view of a fully exploded rotary switch.

FIG. 4 is a perspective view of a rotary switch that is mounted on it panel having a round hole.

### DETAILED DESCRIPTION

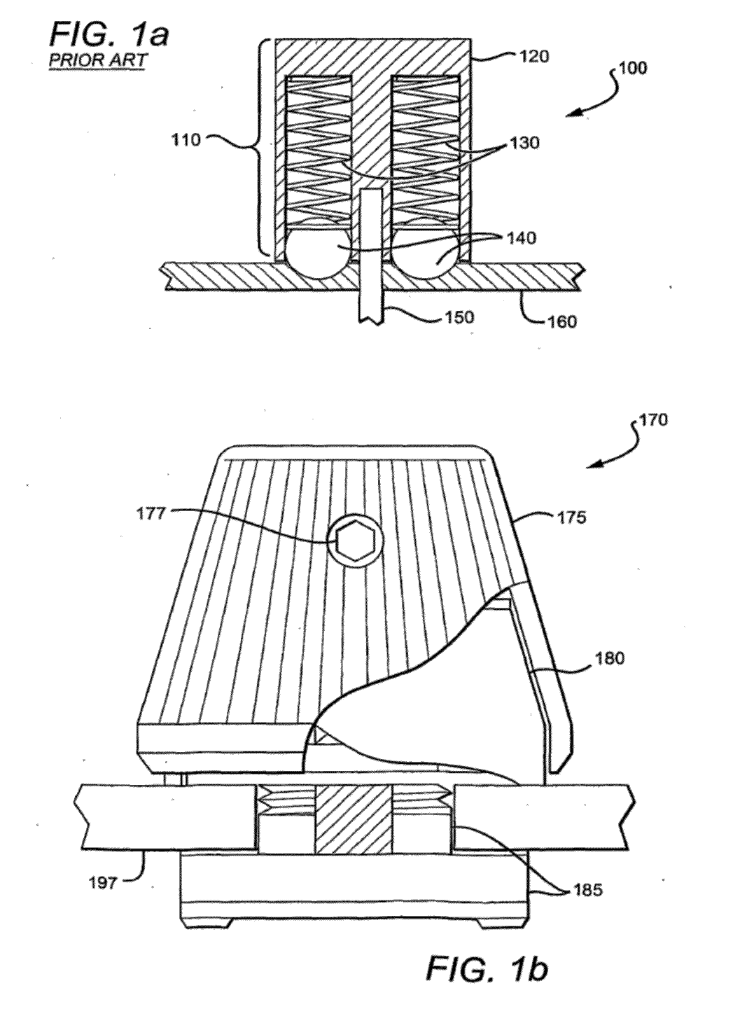

Referring first to FIG. 1a, a prior art rotary switch 100 comprises a detent mechanism 110, a knob 120, springs 130, balls 140, a shaft 150, and a panel 160.

The detent mechanism 110 is comprised at least partially of springs 130 and balls 140. It should be noted that there are two springs 130 and each spring is housed in a channel in the knob 120. Because the springs are housed in the knob, the operation of the detent subassembly is dependent on the knob. It should also be noted that the springs 130 are elongated in a dimension parallel to the shaft. Yet another notable feature of the prior art switch is the extension of the detent mechanism 110 into the panel.

FIG. 1b depicts a rotary switch 170 generally comprised of a knob 175, a detent subassembly 180, a bushing 185, and a panel 197.

A comparison of FIG. 1b with FIG. 1a emphasizes at least two notable distinctions between the two switches depicted. The first distinction is that the prior art switch is dependent upon the knob 120 for housing of the detent 110 and for operation of the switch. The second distinction is that the detent of the prior art switch extends into the panel. Other distinctions exist such as the position of the spring and the quantity of springs.

With regard to the first distinction, prior art dependence on the knob is caused by a design in which the detent is housed within the knob. In the present subject matter, the detent sub-assembly is fully enclosed independent of the knob (i.e. not housed in the knob). The knob 175 is simply held to the shaft by one or more locking screws 177, and the operation of the detent sub-assembly 180 is not altered by removal of the knob 175.

Addressing the second distinction, FIG. 1a depicts the extension of the detent subassembly into the panel. This extension is problematic because additional work is required to prepare the panel to receive a switch. Conversely, FIG. 1 b shows that the entire detent subassembly 180 is on the knob-side of the panel 197, and that only the bushing 185 and shaft (not shown—disposed in the bushing) extend through the panel.

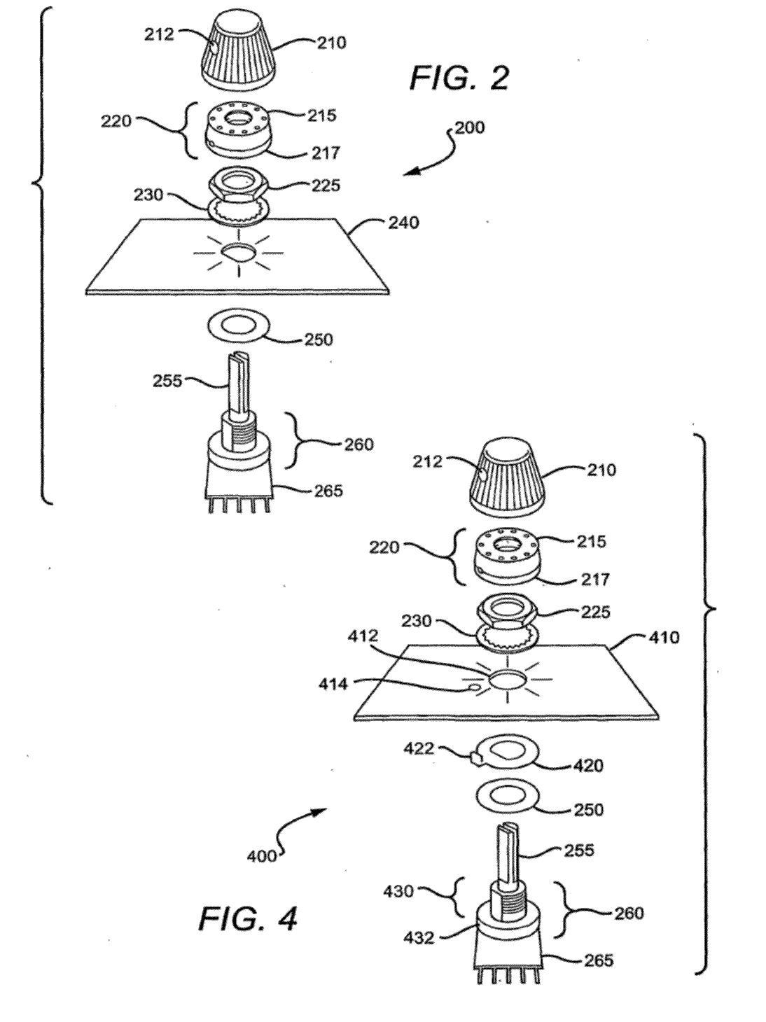

Focusing on FIG. 2, a partially exploded rotary switch generally includes a knob 210, a detent sub-assembly 220, a shaft 255, a bushing 260, and an electrical contact 265.

Knob 210 has a knob locking screw 212 that is used to hold the knob 210 to the shaft 255 which extends up through the panel 240 and through the detent sub-assembly 220. A variety of different knobs are also contemplated including those that are sized and shaped different than the knob in FIG. 2. Alternative knob/shaft configurations are contemplated including a configuration in which two or more knob locking screws are used to hold the knob to the shaft. A preferred manner for altering the electrical connection established by the switch is by rotating the knob. Other manners for altering the connection include rotating the shaft directly and depressing the shaft and/or knob, at times in combination with rotation.

A fully enclosed detent sub-assembly 220 has a detent cap 215 that functions to at least partially enclose the sub-assembly. As used with a detent sub-assembly, the term “fully enclosed” means that the spring and balls of the detent sub-assembly (or their functional equivalents) are held in their functional configuration by a component other than the knob. In FIG. 2, the detent sub-assembly 220 is held in its functional configuration by the sprocket 217 and the cap 215. As noted above, a fully enclosed detent sub-assembly is independent in that the functional aspect of the detent does not need the knob to operate effectively.

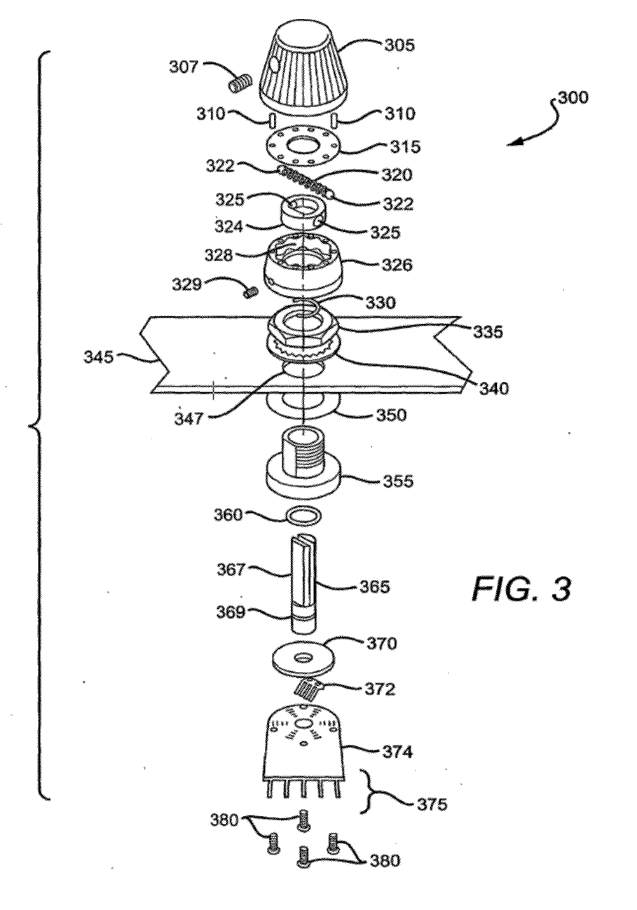

The operation of a rotary switch may be described with reference to FIG. 3, which is a view of a fully exploded rotary switch according to one embodiment. The depicted rotary switch 300 generally comprises a knob 305, a detent sub-assembly, a bushing 355, a shaft 365, an electrical contact 372, and a printed circuit board (PCB) 374.

A knob 305 fits onto a shaft 365 by means of a split in the shaft 365. A knob locking screw 307 (or a plurality of knob locking screws) may optionally secure the knob 305 to the shaft 365. A preferred knob contains a blade (not shown) designed to contact stop pins 310 and limit the rotation of the switch. With respect to stop pins, it is generally contemplated that a pin or pins extend from the detent sprocket up through the detent cap into the enclosure formed by the knob. In a preferred embodiment, stop pins engage a knob blade and limit the rotational travel of the switch. It should be appreciated, however, that the switch can operate without stop pins.

The detent sub-assembly in FIG. 3 is comprised of a sprocket 326 having cylindrical lobes 328, a rotor 324, a spring 320, balls 322, and a cap 315. The rotor 324 is supported by a ridge or shelf (not shown) on the sprocket 326 and the bushing 355 extends substantially up to the ridge, but does not contact the rotor 324. The general operation of a detent subassembly is similar to that of known detents in that switch positions are established by the detent rotor rotating about the cylindrical lobes of the sprocket. In a preferred class of embodiments, the detent sub-assembly comprises a single spring that is horizontally disposed inside the rotor and positioned through the slot of the shaft. The spring loaded balls 322 extend at least partially through holes 325 of the rotor 324.

With regard to the operation of switch 300, the shaft 365 rotates in the interior cavity of the threaded bushing 355 and effects a rotational alignment between the knob 305, the detent rotor 324 and the electrical contacts 372. Rotation of the shaft 365 causes the rotor 324, the spring 320 with its associated balls 322, and the electrical contacts 372 to also rotate—the balls 322 rotating about the inner surface of the sprocket 324 (i.e. the cylindrical lobes 328) and the electrical contacts rotating about the PCB. The spring 320 provides sufficient pressure to effect an appropriate rotational torque of the switch.

Sprocket 326 is held relatively stationary (i.e. does not rotate) by the resistance provided by locking screw 329 against bushing 355. In other embodiments, a bushing can have two (or more) flat sides (a double flat sided bushing). The double flat sided bushing can extend up through a hole in the panel that approximates the shape of the double flat sided bushing. Additionally, the sprocket 326 can have two locking screws, each locking screw 30 cooperating with a flat side of the bushing to provide additional resistance to rotation.

Electrical contacts 372 (e.g. switch wipers or brushes) are mounted on a nonconductive disc 370 (i.e. dielectric) and the contacts 372 cooperate with the circuit configuration on the PCB 374. The PCB 372 is anchored to the threaded bushing 355 by metal rivets 380 or other connectors, however it should be noted that anchoring of the PCB to the bushing is not a requirement. Although not depicted, a PCB can contain additional electronic components (e.g. chips, pins, leads, and so forth) that may interface with components other than the switch. Setting of a switch position, therefore, is generally a function of the interaction among the detent sub-assembly, the shaft, the electrical contact and the PCB. An electrical signal is transmitted through output pins 375. Of course, an electrical signal may travel through other known connectors and the signal may be converted and transmitted wirelessly.

A capture nut 335 and associated lock washer 340 advantageously function to affix a switch to a panel 345 when the nut 302 is threaded to the bushing 355. A sealing gasket 350 and sealing o-ring 360 along with the panel 345 all function to substantially seal the inner workings under a panel (the underside of a panel) from outside contamination caused by moisture, tampering, etc. A panel may be necessary to preserve the safety of a user and the operational integrity of a device. The degree of insulation that a panel provides is at least partially a function of the material that the panel is made from and the degree to which the panel is sealed. For example, the panel depicted in FIG. 3 is made from aluminum and is sealed by gasket 350 and sealing o-ring 360, in combination with panel 345, bushing 355, and slot 369.

It may be important to maintain consistent pressure between electrical contacts 372 and PCB 374. For this reason, a preferred rotary switch limits axis travel of the shaft. One way of doing this is to create a resistance to axial movement by fitting retaining ring 330 into slot 367.

Turning now to the configuration of panel 345, it should be noted that hole 347 in panel 345 is “D” shaped in order to prevent bushing 355 from rotating as the shaft 365 is rotated. Another way of preventing rotation of the bushing is depicted in FIG. 4. As depicted, a “D” shaped non-turn washer 420 is used in combination with a panel having two holes 412, and 414. The larger hole 412 is substantially round and is sized to accept the shaft and the upper portion 430 of the bushing 260. The smaller hole 414 accepts tab 422 of non-turn washer 420 and thereby inhibits rotation of the bushing 260. For purposes of sealing, the hole that accepts the tab may protrude only partially into the panel, rather than through the panel. A further contemplated class of embodiments limits rotation by means of a pin that extends from the base of the bushing 432 into the panel.

Thus, specific embodiments and applications of a low profile switch have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A rotary switch for mounting on a panel, the switch comprising:
a sealing member disposed between a portion of the rotary switch and an underside of the panel;
a detent sub-assembly, where the detent sub-assembly is enclosed and located entirely above the panel and where the detent sub-assembly is comprised of a single substantially horizontal spring, a sprocket having cylindrical lobes, two or more balls, and a cap;
a knob that substantially covers the detent sub-assembly; and
a bushing and a shaft where the bushing and the shaft portions of the rotary switch extend through the panel.
